(19) United States
(12) Patent Application Publication
(10) Pub. No.: US 2025/0266652 A1
(43) Pub. Date: Aug. 21, 2025

(54) METHOD FOR MANUFACTURING TERMINAL CONDUCTIVE PIN, TERMINAL CONDUCTIVE PIN AND CONTACTOR

(71) Applicant: Schneider Electric Industries SAS, Rueil-Malmaison (FR)

(72) Inventors: Zhiping Huan, Shanghai (CN); Yuanzhong Wang, Shanghai (CN); Tao Liu, Shanghai (CN); Huiyong Zhang, Shanghai (CN); Xu Han, Shanghai (CN); Shaofan Li, Shanghai (CN)

(73) Assignee: Schneider Electric Industries SAS, Rueil-Malmaison (FR)

(21) Appl. No.: 19/036,157

(22) Filed: Jan. 24, 2025

(30) Foreign Application Priority Data
Feb. 21, 2024 (CN) 2024101944663

(51) Int. Cl. H01R 43/16; H01R 13/03

(52) U.S. Cl. CPC H01R 43/16; H01R 13/03

(57) ABSTRACT

A method for manufacturing a terminal conductive pin for a contactor, a terminal conductive pin and a contactor. The method includes: providing a blank; pre-electroplating the blank at a first temperature; reflow plating the blank at a second temperature different from the first temperature to form a coating layer on a surface of the blank; and stamping the blank with the coating layer to form the terminal conductive pin including at least one bent part, the coating layer completely covers a surface of the at least one bent part.

The present application claims the priority and benefits of the Chinese Patent Applications No. 202410194466.3, which was filed on Feb. 21, 2024, the disclosure of which is incorporated herein by reference in its entirety as part of the present application.

### TECHNICAL FIELD

The present application relates to a method for manufacturing a terminal conductive pin for a contactor, a terminal conductive pin, and a contactor.

### BACKGROUND

When the contactor is used in salt fog environment, the terminal conductive pin of the contactor will be corroded. In order to improve the corrosion resistance, the terminal conductive pin is covered with a coating layer. In the existing art, a method for manufacturing the terminal conductive pin forms a coating layer by stamping a blank into a conductive pin and then electroplating the coating layer on the conductive pin. However, in this method, when electroplating the conductive pin, it is not easy to form the coating layer on a bent part and a contact part of the conductive pin.

Another method for manufacturing the terminal conductive pin is to firstly electroplate the blank and then stamp the blank into the conductive pin. However, in this method, the stamping process will destroy the coating layer on the blank, especially the coating layer on the bent part and the contact part.

Therefore, neither of the two methods in the existing art can cover the bent part or the contact part of the conductive pin with a coating layer.

### SUMMARY

In order to overcome the above problems, the present application provides a method for manufacturing a terminal conductive pin for a contactor. The method includes:
providing a blank;
pre-electroplating the blank at a first temperature;
reflow plating the blank at a second temperature different from the first temperature to form a coating layer on a surface of the blank; and
stamping the blank with the coating layer to form the terminal conductive pin comprising at least one bent part, and the coating layer completely covers a surface of the at least one bent part.

Advantageously, stamping the blank with the coating layer also enables the terminal conductive pin to be formed with at least one contact part, and the at least one contact part is formed by stamping two different parts of the blank to contact with each other, and the coating layer completely covers a contact surface of the at least one contact part.

Advantageously, the first temperature is smaller than the second temperature.

Advantageously, pre-electroplating the blank at the first temperature comprises pre-electroplating tin on the blank at the first temperature.

Advantageously, reflow plating the blank at the second temperature comprises reflow plating tin on the blank at the second temperature.

Advantageously, the terminal conductive pin is made of copper.

The present application further provides a terminal conductive pin for a contactor, where the terminal conductive pin is formed by abovementioned the method.

The present application further provides a contactor, where the contactor comprises the abovementioned terminal conductive pin.

### BRIEF DESCRIPTION OF DRAWINGS

The above and other features and advantages of exemplary embodiments of the present application will become more apparent from the following detailed description taken in conjunction with the accompanying drawings, which are for illustrative purposes only and are not intended to limit the scope of the present application in any way.

FIG. 1 shows a flowchart of a method for manufacturing a terminal conductive pin for a contactor according to the present application.

FIG. 2 shows an exemplary plan view of a terminal conductive pin according to the present application.

### DETAILED DESCRIPTION

In order to make the purpose, technical solution and advantages of the technical solution of the present disclosure more clear, the technical solution of the embodiment of the present disclosure will be described clearly and completely with the accompanying drawings of specific embodiments of the present disclosure. Like reference numerals in the drawings represent like parts. It should be noted that the described embodiment is a part of the embodiment of the present disclosure, not all embodiments. Based on the described embodiments of the present disclosure, all other embodiments obtained by ordinary skilled in the field without creative labor belong to the scope of protection of the present disclosure.

Compared with the embodiment shown in the attached drawings, the feasible embodiments within the protection scope of the present disclosure may have fewer components, other components not shown in the attached drawings, different components, components arranged differently or components connected differently, etc. Furthermore, two or more components in the drawings may be implemented in a single component, or a single component shown in the drawings may be implemented as a plurality of separate components.

Unless otherwise defined, technical terms or scientific terms used herein shall have their ordinary meanings as understood by people with ordinary skills in the field to which the present disclosure belongs. The words “first”, “second” and similar words used in the specification and claims of the patent application of the present disclosure do not indicate any order, quantity or importance, but are only used to distinguish different components. When the number of parts is not specified, the number of parts can be one or more. Similarly, similar words such as “a”, “an” and “the” do not necessarily mean quantity limitation. Similar words such as “including” or “containing” mean that the elements or objects appearing before the word cover the elements or objects listed after the word and their equivalents, without excluding other elements or objects. “Up”, “Down”, “Left” and “Right” are only used to indicate the relative orientation relationship when the equipment is used or the orientation relationship shown in the attached drawings. When the absolute position of the described object changes, the relative orientation relationship may also change accordingly.

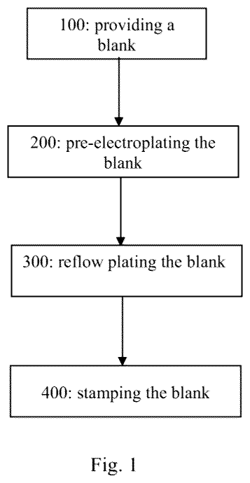

FIG. 1 shows a flowchart of a method for manufacturing a terminal conductive pin for a contactor according to the present application. In step 100, a blank is provided, the blank is preferably made of copper, but other materials can be used as needed. Next, in step 200, the blank is pre-electroplated, for example, pre-electroplated with tin, at a first temperature. In step 300, the blank is reflow plated (for example, reflow plated with tin) at a second temperature, which is different from the first temperature, to form a coating layer on the surface of the blank. The first temperature is preferably smaller than the second temperature.

It should be understood that, in step 200, a first coating layer is formed on the surface of the blank, and in step 300, the first coating layer will be melted to finally form the coating layer, and the adhesion of the coating layer to the surface of the blank is improved by reflow plating. In the case that the terminal conductive pin is made of copper and tin is reflow plated, the coating layer is generally a copper-tin alloy.

In step 400, the blank with the coating layer is stamped to form the terminal conductive pin including at least one bent part, and the coating layer completely covers the surface of the at least one bent part.

In step 400, the blank with the coating layer is stamped to enable the terminal conductive pin to be formed with at least one contact part, the at least one contact part is formed by stamping two different parts of the blank to contact with each other, and the coating layer completely covers a contact surface of the at least one contact part.

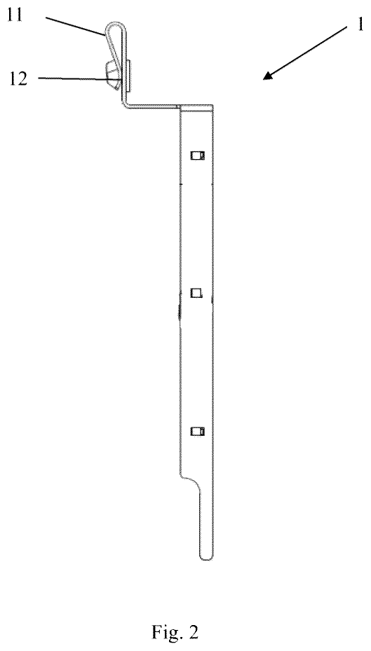

FIG. 2 shows a plan view of a terminal conductive pin according to an example. The terminal conductive pin 1 includes at least one bent part 11, and a surface of the at least one bent part 11 is covered with a coating layer. The terminal conductive pin 1 includes at least one contact part 12, and the contact surface of the at least one contact part 12 is covered with a coating layer. The present application also provides a contactor including such a terminal conductive pin.

In the manufacturing process of the terminal conductive pin, the bent part and the contact part are generally parts that are not easy to be covered with a coating layer. The terminal conductive pin manufactured by the method disclosed by the present application enables the coating layer to completely cover the bent part and the contact part, thereby improving the salt fog corrosion resistance of the terminal conductive pin and reducing the manufacturing cost.

Although the present application has been described in the specification and illustrated in the drawings on the basis of referring to various embodiments, those skilled in the art can understand that the above-mentioned embodiments are only preferred embodiments, and some technical features in the embodiments may not be necessary for solving specific technical problems, so these technical features may not be needed or omitted without affecting the solution of technical problems or the formation of technical solutions; Moreover, the features, elements and/or functions of one embodiment can be combined, combined or coordinated with those of one or more other embodiments as appropriate, unless the combination, combination or coordination is obviously impracticable.

1. A method for manufacturing a terminal conductive pin for a contactor, wherein the method comprises:
providing a blank;
pre-electroplating the blank at a first temperature;
reflow plating the blank at a second temperature different from the first temperature to form a coating layer on a surface of the blank; and
stamping the blank with the coating layer to form the terminal conductive pin comprising at least one bent part, and the coating layer completely covers a surface of the at least one bent part.

2. The method according to claim 1, wherein stamping the blank with the coating layer also enables the terminal conductive pin to be formed with at least one contact part, and the at least one contact part is formed by stamping two different parts of the blank to contact with each other, and the coating layer completely covers a contact surface of the at least one contact part.

3. The method according to claim 1, wherein the first temperature is smaller than the second temperature.

4. The method according to claim 1, wherein pre-electroplating the blank at the first temperature comprises pre-electroplating tin on the blank at the first temperature.

5. The method according to claim 1, wherein reflow plating the blank at the second temperature comprises reflow plating tin on the blank at the second temperature.

6. The method according to claim 1, wherein the terminal conductive pin is made of copper.

7. A terminal conductive pin for a contactor, wherein the terminal conductive pin is formed by the method according to claim 1.

8. A contactor, wherein the contactor comprises the terminal conductive pin according to claim 7.
